(19) United States
(12) Patent Application Publication
(10) Pub. No.: US 2011/0116226 A1
(43) Pub. Date: May 19, 2011

(54) SERVER CHASSIS

(76) Inventor: Yi-Lin YANG, Taipei County (TW)

(21) Appl. No.: 12/619,186

(22) Filed: Nov. 16, 2009

(51) Int. Cl. G06F 1/20

(52) U.S. Cl. 361/679.48

(57) ABSTRACT

A server chassis having a low-profile characteristic is disclosed to include a chassis shell, which defines an accommodation chamber that accommodates an electronic device and a motherboard, a fan module located on one open side of the accommodation chamber in the chassis shell and defining a mounting space in the accommodation chamber, and a connector module, which includes a housing movable in and out of the mounting space inside the chassis shell and locked to the chassis shell with screws, a plurality of peripheral apparatuses carried in the housing of the connector module and an adapter board mounted on the rear side of the housing for the connection of the electronic device, the electric fans and the peripheral apparatuses.

### BACKGROUND OF THE INVENTION

1. Field of the Invention

The present invention relates to computer server technology and more particularly, to a low-profile server chassis, which has a relatively wider connector module slidably mounted in the chassis shell above a relatively narrower fan module so that a sufficient space is defined in the chassis shell for the mounting of one of different models of motherboards from different suppliers.

2. Description of the Related Art

In this information era, various different electronic products are intensively used in our surroundings to provide different services. Following development of modern technology, versatile multipurpose and multifunction electronic products are continuously created to serve people. These advances electronic products are commonly controlled to work by a computer. In consequence, computer plays an important role.

Subject to improvement of data processing speed and efficiency, big capacity hard disks are necessary for storing more data. For storing more data, a computer may be equipped with two or more hard disks. Subject to different requirements, a computer system may require added hardware equipment such as CD-ROM, DVD copier, and etc. When multiple peripheral apparatus are used with a computer, the arrangement of transmission cables, the operation and the maintenance and cleaning works of the peripheral apparatus become complicated.

Further, a server for an industrial computer generally has a motherboard, power supply unit, cooling fans and other component parts arranged therein. The arrangement of these component parts is complicated. More particularly, an accessible space must be left to facilitate plugging and unplugging of transmission cables or electric connectors. This space limitation can easily be overcome with respect to the installation of a power supply unit or fan module. However, because different models of computer motherboards from different suppliers have different dimensions, it is difficult to define a space in a server chassis for the mounting of a motherboard without interfering with plugging and unplugging of transmission cables or electric connectors. There are some designs in which hardware devices are carried on a cover plate that is covered on the chassis shell of the server chassis. Thus, the installation of the hardware devices does not occupy the internal space of the chassis shell. However, this arrangement complicates plugging and unplugging between the hardware devices and the motherboard. When dismounting the cover plate from the chassis shell, the transmission cables or bus lines of the hardware devices may be stretched and damaged accidentally.

Regular commercial server chassis include 3U chassis (having 3 layers of 5.25″ drive space) and 4U chassis (having 4 layers of 5.25″ drive space). In a 4U chassis, 8 disk drives and a power supply unit are installed. The capacity of the power supply unit may be determined subject to requirements. However, when a big size motherboard is used (for the installation of two CPUs) to provide enhanced operation speed, the power supply unit must be mounted in the front side of the chassis shell. In this case, the number of the hard disk drives must be controlled. Therefore, when either kind of power supply unit is used, the number of the hard disk drives must be controlled to fit the installation of a big size motherboard. When a big number of hard disk drives are used, the motherboard mounting space will be relatively decreased. Thus, the user cannot freely utilize the limited internal space of the chassis shell to fit different requirements without limitation on functional performance.

### SUMMARY OF THE INVENTION

The present invention has been accomplished under the circumstances in view. It is one object of the present invention to provide a server chassis, which has a low profile characteristic. It is another object of the present invention to provide a server chassis, which facilitates cleaning and maintenance works. It is still another object of the present invention to provide a server chassis, which automatically controls the operation of cooling fans subject to the level surrounding temperature, saving power consumption.

To achieve these and other objects of the present invention, a server chassis comprises a chassis shell that defines an accommodation chamber, a fan module located on one open side of the accommodation chamber in the chassis shell and defining a mounting space in the accommodation chamber, and a connector module mounted in the mounting space above the fan module. The connector module has a width greater than the fan module so that the connector module and the fan module define a space in the accommodation chamber for accommodating one of different models of motherboards from different suppliers. Thus, the internal space of the chassis shell is fully utilized for accommodating an electronic device, a motherboard and the fan module, providing a low profile characteristic.

Further, the chassis shell comprises two upright sidewalls arranged at two opposite lateral sides of the accommodation chamber, and two rails located on each of the two upright sidewalls at different elevations for guiding the housing of the connector module in and out of the mounting space, facilitating performance of cleaning and maintenance works and mounting and dismounting of the transmission cables of the electronic device in the chassis shell and the electric fans of the fan module and performance of.

Further, the adapter board comprises a plurality of electric connectors arranged on the front and rear sides for the connection of the transmission cables of the electronic device, peripheral apparatuses being carried in the housing of the connector module and electric fans of the fan module. Further, the adapter board carries a plurality of electronic components and a control circuit adapted for detecting surrounding temperature and controlling the operation speed of the electric fans subject to the surrounding temperature detection result.

### BRIEF DESCRIPTION OF THE DRAWINGS

FIG. 1 is an oblique elevation of a server chassis in accordance with the present invention.

FIG. 2 is an exploded view of the server chassis in accordance with the present invention.

FIG. 3 is an exploded view of a part of the present invention, showing the structure of the connector module.

FIG. 4 is a sectional side view of the server chassis in accordance with the present invention.

FIG. 5 is a schematic sectional side view of the present invention, showing the connector module pulled out of the mounting space of the chassis shell.

### DETAILED DESCRIPTION OF THE PREFERRED EMBODIMENT

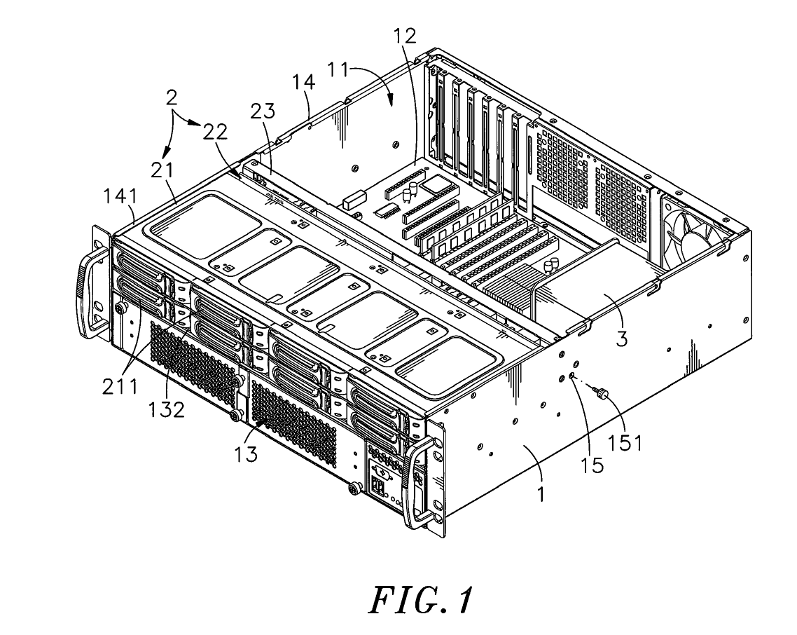

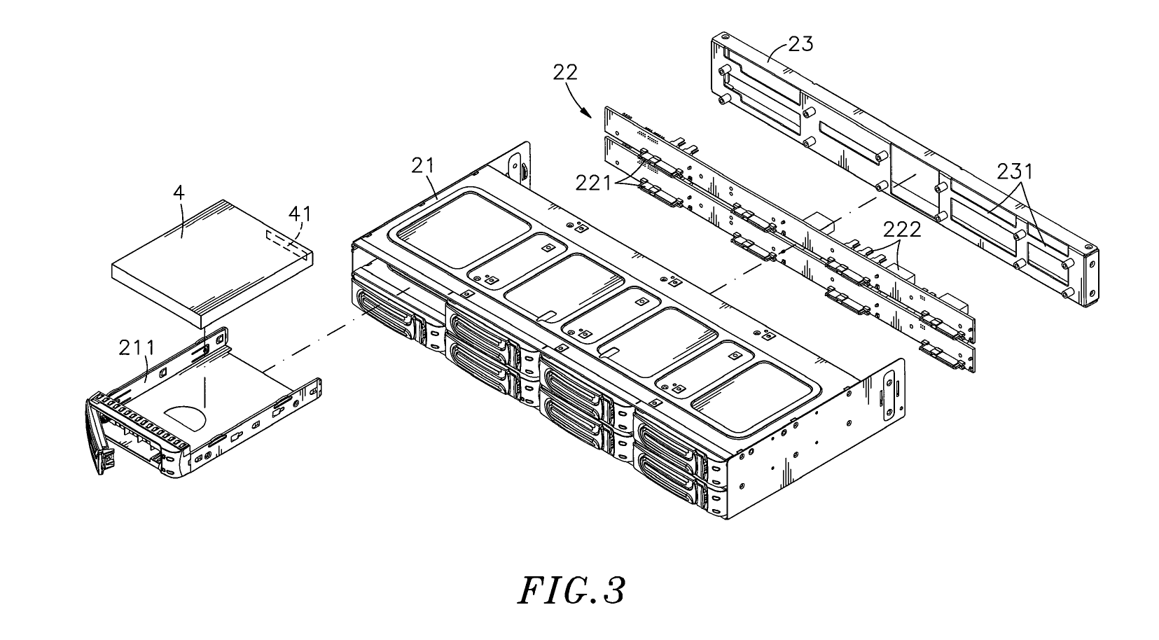

Referring to FIGS. 1-3, a server chassis in accordance with the present invention is shown comprising a chassis shell 1 and a connector module 2.

The chassis shell 1 can be a shell for industrial computer server, comprising an accommodation chamber 11 adapted for accommodating an electronic device 3 and a motherboard 12, a fan module 13 located on one open side of the accommodation chamber 11, a mounting space 111 defined within the accommodation chamber 11 between two opposite upright sidewalls 14 of the chassis shell 1 and above the fan module 13, two rails 141 located on each of the two opposite upright sidewalls 14 in the mounting space 111 at different elevations for holding the connector module 2, a stop rod 142 perpendicularly extended from each of the two opposite upright sidewalls 14 in the mounting space 111 adjacent to associating two rails 141, a plurality of mounting through holes 15 respectively cut through each of the two opposite upright sidewalls 14 and a plurality of screws 151 respectively mounted in the mounting through holes 15. The fan module 13 comprises a plurality of electric fans 131, a fan holder frame 132 holding the electric fans 131 in a row and a locating hole 133 located on the middle of the top wall of the fan holder frame 132.

The connector module 2 is mounted in the mounting space 111 inside the chassis shell 1 above the fan module 13, comprising a housing 21 and an adapter board 22. The housing 21 has a width greater than the fan module 13. Further, the housing 21 houses an array of trays 211, comprising a stop plate 24 protruded from the rear bottom side thereof corresponding to the locating hole 133 of the fan holder frame 132 of the fan module 13 and a plurality of mounting through holes 25 symmetrically disposed at two opposite lateral sides thereof for receiving the screws 151. Further, each tray 211 carries a respective peripheral apparatus 4. A mounting plate 23 is fastened to the rear side of the housing 21 to hold the adapter board 22 in the rear side of the housing 21. The adapter board 22 carries a plurality of electronic components and a control circuit (not shown). Further, the adapter board 22 comprises a plurality of first electric connectors, for example, electric plugs 221 disposed at one side thereof and respectively electrically connected to the peripheral apparatuses 4, and a plurality of second electric connectors, for example, electric sockets 222 disposed at the other side thereof and inserted through respective slots 231 on the mounting plate 23.

The electronic device 3 can be a power adapter, electronic fan or circuit board, having transmission cables 31 electrically connectable to the electric sockets 222 of the adapter board 22. The peripheral apparatus 4 carried in each tray 211 can be a hard disk drive, CD-ROM, DVD copier or the like. Each tray 211 can be made in the form of a sliding box slidably detachably mountable in the housing 21. Each peripheral apparatus 4 has an electric port 41 located on the rear side for the connection of one electric plugs 221 of the adapter board 22. Thus, the peripheral apparatuses 4 are electrically connected with the electronic device 3 by means of the adapter board 22. Further, the transmission cables 31 of the electronic device 3 can be signal cables or power cables for transmission of data or power supply.

During installation, insert the housing 21 of the connector module 2 in between the two rails 141 on each of the two opposite upright sidewalls 14 of the chassis shell 1 into the accommodation chamber 11 to the extent where the housing 21 is stopped at the stop rods 142, avoiding damaging other electronic component parts in the chassis shell 1. At this time, the transmission cables 31 of the at least one electronic device 3 are respectively connected to respective electric sockets (not shown) on the motherboard 12 and the electric sockets 222 of the adapter board 22. After the housing 21 of the connector module 2 has been inserted into the accommodation chamber 11 and stopped at the stop rods 142, the mounting through holes 25 of the connector module 2 are respectively aimed at the mounting through holes 15 of the chassis shell 1. At this time, thread the screws 151 into the mounting through holes 25 respectively to affix the connector module 2 to the chassis shell 1.

According to the present preferred embodiment, the connector module 2 is mounted in the chassis shell 1 by means of inserting the housing 21 of the connector module 2 in between the two rails 141 on each of the two opposite upright sidewalls 14 of the chassis shell 1 into the accommodation chamber 11 and then mounting the screws 151 in the mounting through holes 15 of the chassis shell 1 and the mounting through holes 25 of the connector module 2 to lock the connector module 2 to the chassis shell 1. However, this mounting arrangement is not a limitation. Alternatively, the connector module 2 can be pivotally coupled to the chassis shell 1 so that the connector module 2 can be turned in and out of the accommodation chamber 11 conveniently. Other mounting techniques may be selectively employed, allowing the connector module 2 to be moved in and out of the chassis shell 1 conveniently.

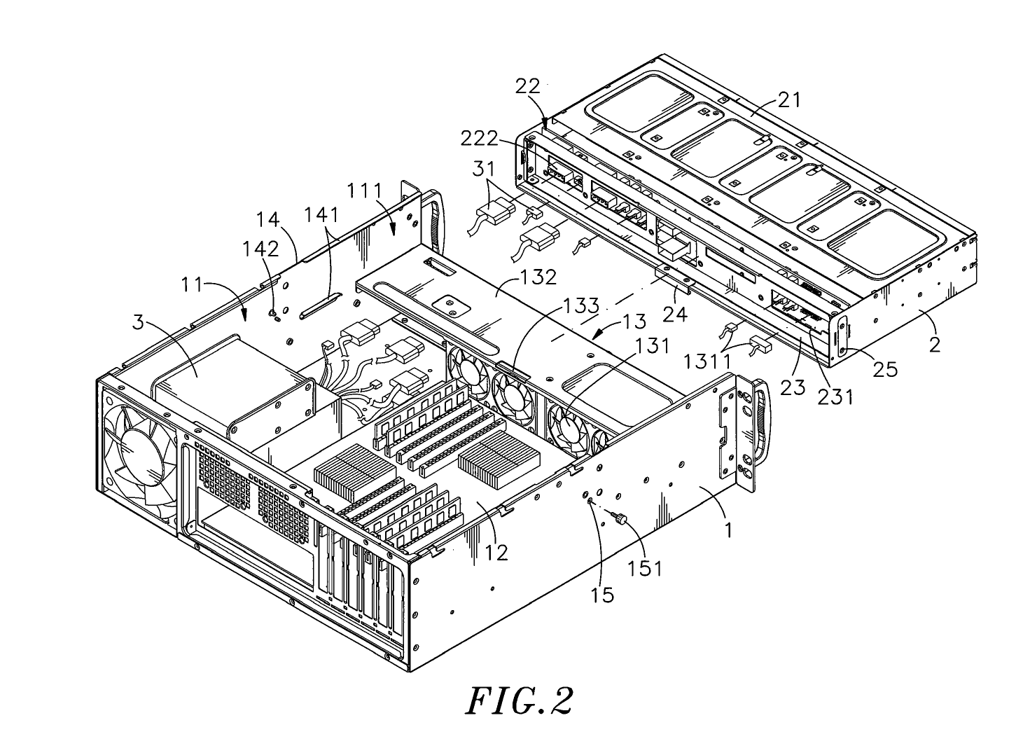

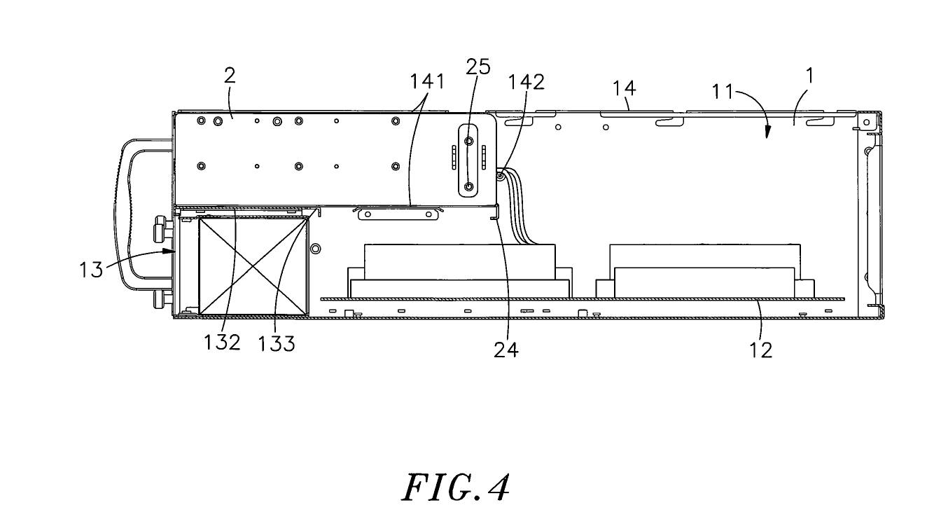

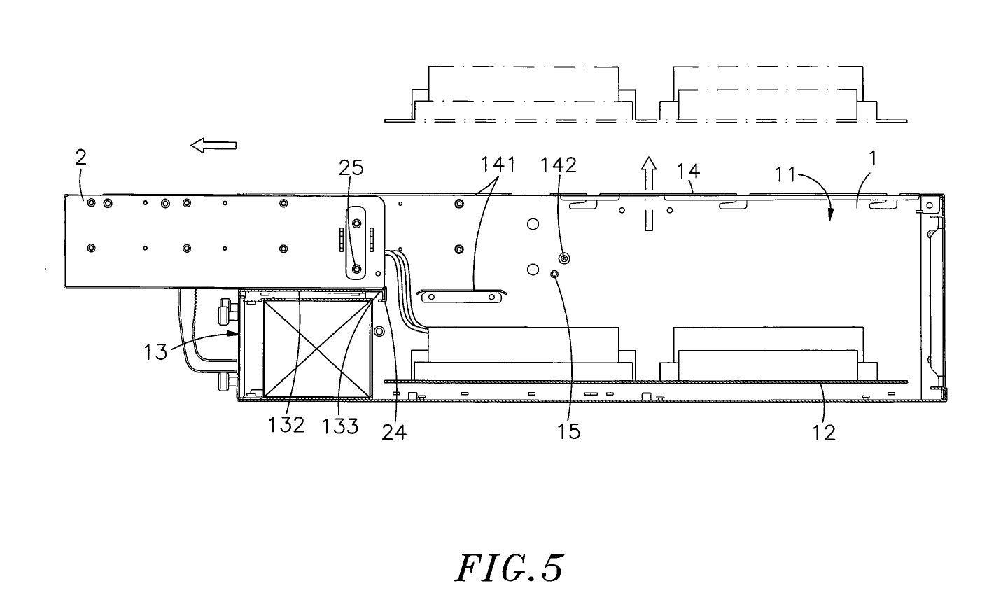

Referring to FIGS. 4 and 5 and FIG. 2 again, a top cover panel (not shown) is covered on the top open side of the chassis shell 1 to protect the connector module 2 against dust, assuring signal or power transmission stability. When a cleaning, maintenance or troubleshooting work is necessary, remove the top cover panel from the chassis shell 1, and then remove the screws 151 from the connector module 2 and the chassis shell 1, and then pull the housing 21 of the connector module 2 backwards along the rails 141 out of the mounting space 111. At this time, the stop plate 24 of the housing 21 is forced into the locating hole 133 of the chassis shell 1 to limit further backward movement of the connector module 2 relative to the chassis shell 1, avoiding falling of the connector module 2 out of the chassis shell 1. The user can then lift the connector module 2 from the fan module 13 and remove the connector module 2 out of the chassis shell 1. This connector module mounting and dismounting arrangement is quick simple without any tools. Thereafter, the user can disconnect the transmission cables 31 of the electronic device 3 and the transmission cables 1311 of the fan module 13 from the adapter board 22. Therefore, the invention facilitates maintenance and cleaning works.

As stated above, the housing 21 of the connector module 2 is mounted in the mounting space 111 above the fan module 13 and has a width greater than the fan module 13, the space defined in the chassis shell 1 behind the fan module 13 and beneath the connector module 2 is suitable for the mounting of any of a variety of motherboards 12 from different suppliers, i.e., the invention fully utilizes the internal space of the chassis shell 1 for accommodating the electronic device 2, the motherboard 12 and the fan module 13, providing a low profile characteristic.

According to the present preferred embodiment, the connector module 2 is mounted in the chassis shell 1 above the fan module 13 and movable in and out of the mounting space 111 when unlocked. Alternatively, the connector module 2 can be mounted in the chassis shell 1 at the bottom side beneath the fan module 13 such that the connector module 2, the electronic device 3 and the fan module 13 define a space inside the chassis shell 1 for the mounting of the motherboard 12. Further, as stated above, the adapter board 22 has the electric plugs 221 and electric sockets 222 thereof arranged at two opposite sides for the connection of the electric ports 41 of the peripheral apparatuses 4 and transmission cables 31 of the electronic device 3. Based on the functioning of the electronic components and control circuit of the adapter board 22, the adapter board 22 controls the operation speed of the electric fans 131 of the fan module 13 subject to the temperature inside the chassis shell 1, facilitating quick dissipation of heat from the electronic device 3 and saving much power consumption. It is to be understood that the technique of using control circuit means to detect surrounding temperature and to control the operation speed of the electric fans 131 subject to the level of the temperature detected is of the known art and not within the scope of the invention, and therefore no further detailed description in this regard is necessary. Further, the adapter board 22 can provide electric connector means for the connection of electronic devices to expand the capacity and/or functions of the server chassis.

The present disclosure having been thus described with particular reference to the preferred embodiment thereof, it will be obvious that various modifications and changes may be made therein without departing from the spirit and scope of the present invention. Accordingly, the invention is not to be limited except as by the appended claims.

What the invention claimed is:

1. A server chassis, comprising:
a chassis shell, said chassis shell comprising an accommodation chamber, which accommodates an electronic device and a motherboard, a fan module located on one open side of said accommodation chamber, and a mounting space defined within said accommodation chamber and surrounded by said fan module, said electronic device and said motherboard; and
a connector module mounted in said mounting space inside said chassis shell, said connector module comprising a housing and an adapter board mounted on a rear side of said housing, said housing carrying a plurality of peripheral apparatuses in a front side thereof, said adapter board comprising a plurality of first electric connectors disposed at one side thereof for the connection of the peripheral apparatus in said housing respectively and a plurality of second electric connectors disposed at an opposite side thereof for the connection transmission cables of said electronic device.

2. The server chassis as claimed in claim 1, wherein said housing of said connector module is mounted in said mounting space inside said chassis shell above said fan module, said housing having a transverse width greater than said fan module.

3. The server chassis as claimed in claim 1, wherein said housing of said connector module is mounted in said mounting space inside said chassis shell beneath said fan module, said housing having a transverse width greater than said fan module.

4. The server chassis as claimed in claim 1, wherein said connector module further comprises an array of trays mounted in said housing, each said tray carrying one said peripheral apparatus.

5. The server chassis as claimed in claim 1, wherein said connector module further comprises a mounting plate fastened to the rear side of said housing to hold said adapter board in place, said mounting plate comprising a plurality of slots for the passing of said second electric connectors of said adapter board.

6. The server chassis as claimed in claim 1, wherein said chassis shell comprises two upright sidewalls arranged at two opposite lateral sides of said accommodation chamber, and two rails located on each of said two upright sidewalls at different elevations for guiding said housing of said connector module in and out of said mounting space.

7. The server chassis as claimed in claim 1, wherein said chassis shell comprises a plurality of mounting through holes on each of two opposite upright sidewalls thereof; said housing of said connector module comprises a plurality of mounting through holes respectively connected to the mounting through holes of said chassis shell by respective screws.

8. The server chassis as claimed in claim 1, wherein said fan module comprises a plurality of electric fans and a fan holder frame holding said electric fans in a row, said fan holder frame and a locating hole located on a middle part of a top wall thereof; said connector module comprises a stop plate protruded from a rear bottom side thereof for engaging into the locating hole of said fan holder frame of said fan module upon a backward displacement of said connector module relative to said chassis shell.

9. The server chassis as claimed in claim 1, wherein said fan module comprises a plurality of electric fans and a fan holder frame holding said electric fans in a row, each said electric fan comprising a transmission cable respectively connected to one said second electric connector of said adapter board; said adapter board carrying a plurality of electronic components and a control circuit adapted for detecting surrounding temperature and controlling the operation speed of said electric fans subject to the surrounding temperature detection result.

10. The server chassis as claimed in claim 1, wherein said peripheral apparatuses include at least one of hard disk drive, CD-ROM and DVD copier.
